(19) United States
(12) Patent Application Publication
(10) Pub. No.: US 2015/0339595 A1
(43) Pub. Date: Nov. 26, 2015

(54) METHOD AND SYSTEM FOR BALANCING RENTAL FLEET OF MOVABLE ASSET

(71) Applicants: Peter Soutter, Dublin (IE); Simon Wilson, Dublin (IE)

(72) Inventors: Peter Soutter, Dublin (IE); Simon Wilson, Dublin (IE)

(21) Appl. No.: 14/323,081

(22) Filed: Jul. 3, 2014

Related U.S. Application Data
(60) Provisional application No. 62/001,740, filed on May 22, 2014.

(51) Int. Cl. G06Q 10/02; G06Q 30/02

(52) U.S. Cl. CPC G06Q 10/02; G06Q 30/0202; G06Q 30/0207

(57) ABSTRACT

A method and a system for balancing rental fleet of movable assets are provided. In one aspect, the method is executed by a processor and comprises receiving, at a booking time, a booking request for an asset, the booking request including a pickup location and a pickup time; in response to the booking request, calculating a predicted quantity of assets at the pickup location and the pickup time based at least in part on current asset location information and future booking data, and calculating a target quantity of assets at the pickup location and the pickup time based on past booking data; calculating a discount parameter in accordance with said predicted quantity of assets and said target quantity of assets; and generating a booking price in accordance with the discount parameter.

### CROSS REFERENCE TO RELATED APPLICATIONS

This application claims priority from U.S. Provisional Patent Application Ser. No. 62/001,740, filed May 22, 2014 and incorporated herein by reference in its entirety.

### BACKGROUND

The present disclosure relates to a method and a system for ensuring that short-term rental assets meet demand. More particularly, the present disclosure relates to a method and a system for balancing out short-term one-way rentals of movable assets (e.g., cars, bikes, vans, motorbikes, scooters, personal transporters, and the like) within a geographical region (e.g., a city, a state, a country, and the like) and ensuring that movable assets are distributed around the region according to demand.

Short-term rentals companies currently work with manual redistribution of assets and static pricing. A car sharing system, or car share scheme, is a service in which cars are made available to individuals on a short term rental basis. Car sharing schemes exist in many cities around the world, operated by providers including Zipcar, Car2Go, Drive Now, GoGet, and Hertz on Demand. Bicycle share schemes with similar short term rental systems are also in operation internationally and examples of them include Barclays Cycle Hire in London, Velib in Paris, OV-fiets in the Netherlands, and the Hubway system in Boston.

Fleet balancing techniques are currently not used in the short-term rental market. The lack of prediction and demand forecasting means that, in the short-term rental of assets within a geographical region (such as a city), operators face a problem of balancing out their fleet and ensuring that the assets are placed in or returned to areas of demand. As a result, short terms asset rental companies cannot currently provide advanced bookings. Customers search current locations for cars or movable assets on their mobile apps or web booking systems, or physically find available assets. Short terms asset rental companies have no way of knowing where their assets will be placed and therefore cannot provide their customers with advance bookings.

Companies providing short term rental schemes currently employ fleet managers for each zone of their geographical region, to redistribute assets to areas of perceived demand. Because fleet managers focus on a fixed area, there is no overview of demand. Fleet managers dispatch employees of the asset management companies to manually move their assets around the city. The schemes currently provide pricing that is not affected by current or predicted demand in the system.

In terms of pricing, the company sets a flat rate per minute or per hour price for a journey and that price is fixed regardless of demand. The price of the use of the bike remains static and does not change according to current demand or predicted demand. Car Share companies set a per minute or per hour price for a rental that is then fixed. Car Rental companies, such as Hertz, Avis and Enterprise, use a form of revenue management that calculates a price based on the number of cars in a depot. Car rental depots often hold hundreds or thousands of cars. Car rental has a range of categories of cars in the depot ranging from economy to luxury. The number of cars in the depot based on current bookings is then used to calculate the optimum price. Short-term rentals differ from traditional car rental in that the assets are often uniform or have a small number of categories.

In view of the above, there is a need to develop a new method and a new system for ensuring that short-term rental assets meet demand by employing fleet balancing techniques.

### SUMMARY

The present disclosure provides a method and a system for ensuring a balanced rental fleet in the short term rental of movable assets in a city or geographical region. In one embodiment, the present disclosure provides a method that is executed by a computer processor for predicting demand for movable assets within a city and then influencing the assets location through pricing, gamification, points, rewards, badges or any similar incentives.

In one aspect, the method of the present disclosure includes receiving, at a booking time, a booking request for a asset, the booking request including a pickup location and a pickup time, in response to the booking request, calculating a predicted quantity of assets at the pickup location and the pickup time based at least in part on current asset location information and future booking data, and calculating a target quantity of assets at the pickup location and the pickup time based on past booking data, calculating a discount parameter in accordance with said predicted quantity of assets and said target quantity of assets, and generating a booking price in accordance with the discount parameter.

In another aspect, the method further includes rejecting the booking request when the predicted quantity of assets is less than or equal to a predetermined quantity.

In a further aspect, calculating the predicted quantity of assets includes retrieving a first quantity of assets that is actually located at the pickup location at the booking time in accordance with the current asset location information, subtracting from the first quantity a second quantity of assets to be picked up from the pickup location between the booking time and the pickup time in accordance with the future booking data, and adding to the first quantity a third quantity of assets to be dropped off to the pickup location between the booking time and the pickup time in accordance with the future booking data.

In a further aspect, the booking price is a full price when the discount parameter is less than or equal to a predetermined discount threshold value. In one aspect, the booking price is a discounted price when the discount parameter is greater than a predetermined discount threshold.

In another aspect, calculating the discount parameter includes calculating a pickup ratio and a dropoff ratio, and calculating a fraction of the pickup ratio and the dropoff ratio.

In one aspect, calculating the pickup ratio comprises calculating a first fraction of a first numerator and a first denominator. The first numerator is the predicted quantity of assets at the pickup location and the pickup time subtracted by a value one. The first denominator is the target quantity of assets at the pickup location and the pickup time.

In one case, the booking request further includes a dropoff location and a dropoff time. In this case, calculating the dropoff ratio comprises calculating a predicted quantity of assets at a dropoff location and a dropoff time based at least in part on the current asset location information and the future booking data, calculating a target quantity of assets at the dropoff location and the dropoff time based on past booking data, and calculating a second fraction of a second numerator and a second denominator. The second numerator is the predicted quantity of assets at the dropoff location and the dropoff time added by a value one. The second denominator is the target quantity of assets at the dropoff location and the dropoff time.

In a further case, the booking request does not include a dropoff location but provides the price for dropping off at a set of possible drop off locations.

In a further case, the booking request does not include a dropoff location and a dropoff time. The prices for dropping off at a set of possible dropoff locations are provided, using as the dropoff time an estimate of the time that is required to move an asset directly from the pickup location to a dropoff location.

In a further case, the booking request does not include a dropoff location and a dropoff time. In this case, calculating the dropoff ratio comprises calculating a proportion of booked assets to be picked up at the pickup location and the pickup time, and to be dropped off at a plurality of dropoff locations and a plurality of dropoff times, calculating a predicted quantity of assets at said plurality of dropoff locations and said plurality of dropoff times based at least in part on the current asset location information and the future booking data, calculating a target quantity of assets at said plurality of dropoff locations and said plurality of dropoff times based on past booking data, and calculating the dropoff ratio in accordance with:

$${\hat{R}}_{dropoff} = \frac{{\sum }_{x} {\sum }_{T} ( PRED ( X , T ) + 1 ) p ( {X}_{pickup} -> X , {T}_{pickup} -> T )}{{\sum }_{x} {\sum }_{T} TARGET ( X , T ) p ( {X}_{pickup} -> X , {T}_{pickup} -> T )} .$$

Notation \hat{R}_{dropoff} denotes the dropoff ratio. Notation PRED(X, T) denotes the predicted quantity of assets at said plurality of dropoff locations X and said plurality of dropoff times T. Notation TARGET(X, T) denotes the target quantity of assets at said plurality of dropoff locations X and said plurality of dropoff times T. Notation p(X_{pickup}→X, T_{pickup}→T) denotes a proportion of assets booked at the pickup location and the pickup time and dropped off at said plurality of dropoff locations X and said plurality of dropoff times T. Notation ΣₓΣ_{T} denotes summations over said plurality of dropoff locations X and said plurality of dropoff times T.

In another embodiment, the present disclosure provides a computer system for pricing a rental asset. The system comprises a booking estimation module configured to: receive, at a booking time, a booking request for a asset, the booking request including a pickup location and a pickup time, calculate a predicted quantity of assets at a pickup location and a pickup time based at least in part on current asset location information and future booking data, and calculate a target quantity of assets at the pickup location and the pickup time based on past booking data; a discount determination module configured to calculate a discount parameter in accordance with said predicted quantity of assets and said target quantity of assets; a price determination module configured to generate a booking price in accordance with the discount parameter; and a booking module configured to complete the booking request.

In one embodiment, the present disclosure provides a method for balancing rental fleet of movable assets, the method being executed by a processor and comprises receiving, at a booking time, a booking request for an asset, the booking request including a pickup location and a pickup time; determining a plurality of possible dropoff locations and a plurality of possible dropoff times in accordance with the pickup location and the pickup time; calculating a plurality of discount parameters in accordance with said pickup location, said pickup time, said possible dropoff locations, and said possible dropoff times, one of the discount parameters being associated with one of the possible dropoff locations; and generating a plurality of booking prices in accordance with said discount parameters, one of the booking prices being associated with one of the possible dropoff locations.

In one case, each of the possible dropoff times is an estimate of time that is required to move an asset from the pickup location to a respective possible dropoff location.

In one case, calculating the discount parameters comprises calculating a first predicted quantity of assets at the pickup location and the pickup time based at least in part on current asset location information and future booking data; calculating a first target quantity of assets at the pickup location and the pickup time based on past booking data; calculating a second predicted quantity of assets at the possible dropoff locations and the possible dropoff times based at least in part on current asset location information and future booking data; calculating a second target quantity of assets at the possible dropoff locations and the possible dropoff times based on past booking data; and calculating the discount parameters in accordance with the first predicted quantity, the first target quantity, the second predicted quantity, and the second target quantity.

In one case, the method further comprises displaying a plurality of location identifiers on a graphic user interface of a client terminal device representing location information of the possible dropoff locations, wherein each of the location identifiers is associated with one of the booking prices.

### BRIEF DESCRIPTION OF THE DRAWINGS

For a better understanding of the present disclosure, together with other and further needs thereof, reference is made to the accompanying drawings and detailed description.

FIG. 1 illustrates a flow diagram of a method for determining price of a rental vehicle, in accordance with an embodiment of the present disclosure.

FIG. 2 illustrates the price offered as a function of the discount function, in accordance with an embodiment of the present disclosure.

FIG. 3 illustrates the price as a function of pickup ratio and dropoff ratio, in accordance with an embodiment of the present disclosure.

FIG. 4 schematically illustrates a block diagram of a computer system for implementing a method for determining rental vehicle booking price, in accordance with an embodiment of the present disclosure.

FIG. 5 schematically illustrates a block diagram of a client terminal device for implementing a method for determining rental vehicle booking price, in accordance with an embodiment of the present disclosure.

FIG. 6 illustrates a graphic user interface of a computer program product displayed on a client terminal device including a plurality of possible dropoff locations and booking prices thereof associated with a pickup location, in accordance with an embodiment of the present disclosure.

### DETAILED DESCRIPTION

Hereafter, embodiments of the present disclosure are described in further detail with reference to the accompanying drawings. It is to be understood that the present disclosure relates to fleet balancing of “movable assets,” such as cars, bikes, vans, motorbikes, scooters, personal transporters, boats, air planes, and the like, within a geographical region, such as a city, a state, a country, and the like. Although descriptions of the present disclosure may refer to one type of movable assets (e.g., a car), it is appreciated that the principle of the present disclosure is equally applicable to all other types of movable assets (e.g., a bike, a boat, an airplane, etc.). It is also appreciated that a movable asset can be collected for rent at one location and dropped off at a subsequent time in another location. The same principle of the present disclosure can be applied in various industries, such as one-way bike rental schemes in cities, traditional car rental that permits one way bookings, etc.

Embodiments of the present disclosure assumes the following:

1) A predetermined geographic region, such as a city, is partitioned into various zones (hereafter referred to as “locations”). A cyclic time period, such as a week or seven days, is partitioned into a set of time spots or slots (hereafter referred to as “times”). Neighboring time spots may be separated with each other by an hour, two hours, one half of an hour, a quarter of an hour, and the like.

2) Data of past bookings include the time that each reservation was made (or booking time), the pick up location and time, and the drop off location and time. An example of the past booking data for Monday, midnight 00:00, at various locations is given in below TABLE 1. The numbers under pickup and dropoff columns are the average numbers of cars picked up at respective locations for past several weeks.

TABLE 1
Past Booking Model

| | time.zone | location | pickup | dropoff |
|---|---|---|---|---|
| 1 | Monday 00:00 | Downtown West | 0.14853865 | 0.11552370 |
| 2 | Monday 00:00 | Downtown North West | 0.12946461 | 0.09576255 |
| 3 | Monday 00:00 | Downtown Hyde Park | 0.16684114 | 0.11262389 |
| 4 | Monday 00:00 | Downtown South West | 0.15874697 | 0.14898152 |
| 5 | Monday 00:00 | Central Station | 0.05952854 | 0.21106373 |
| 6 | Monday 00:00 | Jubilee Park | 0.15916121 | 0.09565936 |

3) Demand of rental vehicles by location and time is predicted by analyzing the past booking data, taking the form of the data in below TABLE 2.

4) Data of future bookings specify the booking time, the pickup location and time, and optional dropoff location and time. Although not necessary, the dropoff location and time of these future bookings is also very valuable and, if available, can improve the performance of disclosed method and system. An example of the future booking data (including six bookings) is given in below TABLE 2.

TABLE 2
Future Booking Data

| | booking .time | pickup time | pickup.loc | dropoff.time | dropoff.loc |
|---|---|---|---|---|---|
| 1 | 2014-05-22 | 2014-05-23 | Queen's Park | 2014-05-23 | The Spit |
| | 21:08:31 | 00:00:00 | South | 00:20:20 | West |
| 2 | 2014-05-22 | 2014-05-23 | Kirribilli | Not | Not |
| | 23:48:55 | 00:00:00 | | Available | Available |
| 3 | 2014-05-22 | 2014-05-23 | Clifton | 2014-05-23 | The Spit |
| | 21:14:13 | 00:02:00 | Gardens | 00:39:10 | East |
| 4 | 2014-05-22 | 2014-05-23 | King's | 2014-05-23 | Maroubra |
| | 21:20:41 | 00:02:00 | Cross NW | 01:13:18 | |
| 5 | 2014-05-22 | 2014-05-23 | University | 2014-05-23 | King's |
| | 23:48:43 | 00:02:00 | of Sydney | 00:16:48 | Cross NE |
| 6 | 2014-05-22 | 2014-05-23 | Bondi | 2014-05-23 | Surry Hills |
| | 23:54:39 | 00:03:00 | South | 00:23:38 | North |

5) Current location of all rental vehicles is known. In one example, each rental vehicle of a rental company is equipped with a global positioning system (GPS) device, and the rental company can obtain the current location information of each rental vehicle real-time (e.g., updated once per minute) by monitoring the GPS device, Such real-time location information of each rental vehicle can be stored in a database of the rental company and made accessible to a customer or a service provider through a computer network.

6) A rental car company is prepared to offer rental rates at a pre-specified set of K+1 prices, P₀>P₁> . . . >P_{K}, where P₀ denotes the full rental price, while Pₙ (for n=1, . . . K) denotes a price lower than the full price.

7) A set of K discount function thresholds, 0<D₁< . . . <Dᵥ, that may be used to determine which price to set. A lookup table may be established to define the relation between the discount function thresholds and the booking prices.

In one embodiment, the rental price can be a price to rent a car per minute, with 5 different predetermined prices Pₙ (n=0, 1, 2, 3, and 4). For example, the standard full price P₀ can be respectively set at 42 cents per minute, and the discounted prices P₁, P₂, P₃, P₄, and P₅ can be respectively set at 38 cents per minute, 34 cents per minute, 30 cents per minute, and 26 cents per minute. The threshold values Dₙ (n=1, 2, 3, and 4) for these prices can be respectively set at 1.3, 1.6, 2.0, and 2.5. As such, a discount function value less than 1.3 gives the standard full price of 42 cents per minute; a discount function value between 1.3 to 1.6 gives a discounted price of 38 cents per minute; a discount function value between 1.6 to 2.0 gives a discounted price of 34 cents per minute; a discount function value between 2.0 to 2.5 gives a discounted price of 30 cents per minute; and a discount function value greater than 2.5 gives a discounted price of 26 cents per minute.

An example of the booking price lookup table is given in below TABLE 3.

TABLE 3
Booking Price Lookup Table

| | | Price Pₙ |
|---|---|---|
| n | Discount Value D | (cents/minute) |
| 0 | ≦1.3 | 42 |
| 1 | (1.3, 1.6] | 38 |
| 2 | (1.6. 2.0] | 34 |
| 3 | (2.0, 2.5] | 30 |
| 4 | >2.5 | 26 |

Broadly speaking, the method of the present disclosure works as follows. A user wants to make a booking to pick up a rental car at a particular location and time. The booking can be done through a web page of the rental car company displayed on the user's computer device, or through a mobile application of the rental car company installed and executed on the user's mobile device. The method compares the actual number of rental cars that is currently predicted to be at the pickup and dropoff locations and times in accordance with future booking data, with the target number of rental cars derived from the predicted demand in accordance with past booking data.

In one embodiment, the past booking data is a collection of the actual number of pickups and dropoffs for a plurality of cyclic time periods (e.g., past several weeks). For example, if a user is booking a rental car in the 17^{th} week of the year 2014 to be picked up in the 18^{th} week of the year 2014, the past booking data may include actual booking data corresponding to the 1^{st} week of the year 2014 through the 16^{th} week of the year 2014. It is appreciated that the past booking data may include data that corresponds to any suitable number of cyclic time periods, for example, from the 1st week of 2012 through the 52^{nd} week of 2013. It is further appreciated that, for other embodiments, a cyclic time period may be a month, a year, and the like.

Prediction of the number of cars at a location and time, as well as the target number, may also be modeled as a function of other relevant factors, including but not limited to weather conditions, and occurrence of one-off events such as concerts and sports games.

A discount is offered if the actual number of cars derived from the future booking data is more than the target number of cars derived from the past booking data. One rationale for offering the discount is that the rental car company wants to encourage cars to be moved away from the pickup location if too many cars would be there. Likewise, if the user gives a dropoff location and time, a discount is offered if the actual number of rental cars at the dropoff location and time is less than the target number of rental cars at the dropoff location and time. One rationale for offering a discount is that the rental car company wants to encourage cars to be moved into the dropoff location if not enough cars would be there.

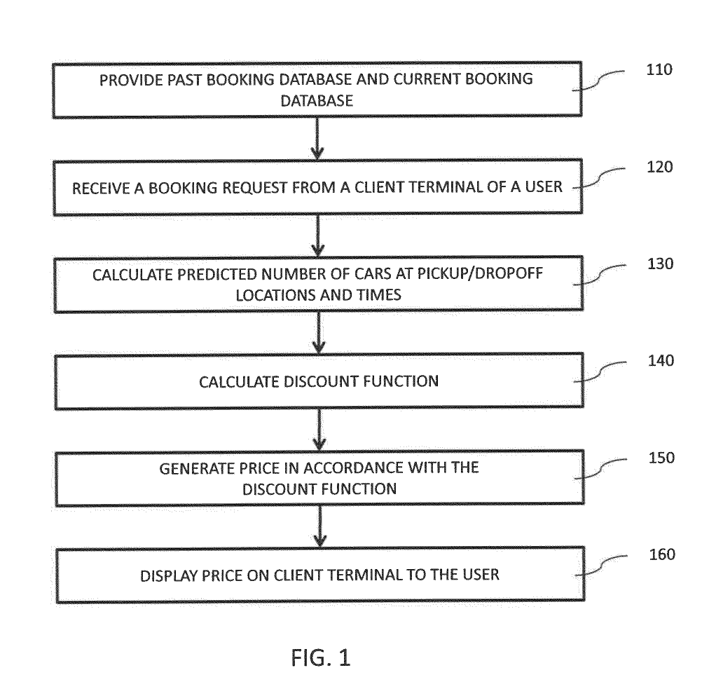

Referring to FIG. 1, there is illustrated a flow diagram of a method for determining price of a rental vehicle, in accordance with an embodiment of the present disclosure. As shown in FIG. 1 in Step 110, a past booking database and a future booking database are provided and hosted in a server device. In one embodiment, the past booking database and the future booking database are relational databases (e.g., MySQL), which respectively include data of past bookings and data of future bookings. In Step 120, at a booking time, a booking request of a rental vehicle is received by a server device from a client terminal device, the booking request including a pickup location within a geographic region and a pickup time within a cyclic time period. In Step 130, in response to the booking request, the server device calculates a predicted number of vehicles at the pickup location and the pickup time based at least in part on the future booking data, and calculates a target number of vehicles at the pickup location and the pickup time based on the past booking data. In Step 140, the server device calculates a discount parameter in accordance with the predicted number of vehicles and the target number of vehicles. In Step 150, the server device generates a booking price in accordance with the discount parameter by referencing a predetermined pricing table. In Step 160, the booking price is displayed to the user after being transmitted from the server device to the client terminal device of the user.

Hereafter, the method for determining rental vehicle price of the present disclosure is described in more detail. The following notations are used:

1) PICKUP(X, T) is the predicted number of rental cars that will be picked up at location X and time T, derived from the past booking data and other relevant factors such as weather and occurrence of one-off events.

2) DROPOFF(X, T) is the predicted number of rental cars that will be dropped off at location X and time T, derived from the past booking data and other relevant factors such as weather and occurrence of one-off events.

3) TARGET(X, T) is the target number of rental cars for location X and time T, derived from a prediction model and the past booking data and other relevant factors such as weather and occurrence of one-off events.

4) PRED(X, T) is the predicted number of rental cars for location X and time T at the booking time T_{book}, derived from the current location information of rental cars (retrieved by monitoring the GPS device on the rental cars) and known bookings (or future booking data).

5) PICKUP.RESERVE(X, T) is the current number of bookings for pickup at location X, time T. This constitutes a portion of the future booking data.

6) DROPOFF.RESERVE(X, T) is the current number of bookings for dropoff at location X, time T. This constitutes a portion of the future booking data.

7) PROP.BOOK(T_{book}; X, T) is the proportion of bookings that are made by booking time T_{book} for location X and time T, derived from the past booking data. In one embodiment, PROP.BOOK(T_{book}; X, T) is defined as the proportion of bookings in the past booking data for location X and time T that had been made by time T_{book}, and has a value between 0 and 1.

An example of the proportion of bookings is given in below TABLE 3. For each time of the week and area of the city, the prop.01, prop.02, prop.03, . . . columns show the proportion of bookings that remain to be made 15, 30, 45, . . . minutes before the time in the time column. For example, for bookings to pick up at midnight (00:00), Monday, from the location of Downtown West, 18.8% of bookings remain to be made with 30 minutes to go (i.e., at 11:30 PM, Sunday). The proportion of bookings gradually reduces to zero when the booking time approaches the pickup time. In this example, these proportions are the same for all times and locations in below TABLE 4.

TABLE 4
Proportion of Bookings

| | time | location | prop.01 | prop.02 | prop.03 | prop.04 | prop.05 |
|---|---|---|---|---|---|---|---|
| 1 | Monday | Downtown | 0.082 | 0.188 | 0.28 | 0.365 | 0.438 |
| | 00:00 | West | | | | | |
| 2 | Monday | Downtown | 0.082 | 0.188 | 0.28 | 0.365 | 0.438 |
| | 00:00 | North West | | | | | |
| 3 | Monday | Downtown | 0.082 | 0.188 | 0.28 | 0.365 | 0.438 |
| | 00:00 | Hyde Park | | | | | |
| 4 | Monday | Downtown | 0.082 | 0.188 | 0.28 | 0.365 | 0.438 |
| | 00:00 | South West | | | | | |
| 5 | Monday | Central | 0.082 | 0.188 | 0.28 | 0.365 | 0.438 |
| | 00:00 | Station | | | | | |
| 6 | Monday | Jubilee | 0.082 | 0.188 | 0.28 | 0.365 | 0.438 |
| | 00:00 | Park | | | | | |

Derivation of Pickup(X, T), Dropoff(X, T) and Target(X, T):

PICKUP(X, T) and DROPOFF(X, T) can be derived from past data or past booking data. In the simplest case, they may be the average number of pickups and dropoffs at location X and time T from past data, as shown in above TABLE 1. It is appreciated that more sophisticated prediction models can be used to derive PICKUP(X, T) and DROPOFF(X, T) by, for example, fitting a statistical model to the past data. A simple expression for the target is to use predicted demand: TARGET(X,T)=PICKUP(X,T). It is appreciated other more sophisticated prediction models can be made to derive TARGET(X, T). In one embodiment, PICKUP(X, T), DROPOFF(X, T), and TARGET(X, T) are stored in one or more databases accessible by client terminal devices through a computer network, and updated periodically (e.g., once a week).

Derivation of Pred(X, T):

Obtaining a value for PRED(X, T) is more challenging. Its value has to be calculated at booking time T_{book}, when the booking price is being determined. In one embodiment, PRED(X, T) can be calculated at the booking time by a server device using server side scripting (e.g., R programming language, PHP, and the like) or by a client terminal device using client side scripting (e.g., JavaScript, VBScript, and the like). A complete formula for PRED(X, T) may be:

PRED(X,T)=No. of rental cars at location X now (e.g., at booking time T_{book})−Predicted no. of pickups at location X between times T_{book} and T+Predicted no. of dropoffs at location X between times T_{book} and T.

The last two terms in the above equation can be derived from a simple formula by looking at the current number of bookings for pickup or dropoff at time T:

Predicted no. of pickups at location X between times T_{book} and T=PICKUP.RESERVE(X,T)+(1−PROP.BOOK(T_{book};X,T))PICKUP(X,T),

and

Predicted no. of dropoffs at location X between times T_{book} and T=DROPOFF.RESERVE(X,T)+(1−PROP.BOOK(T_{book};X,T))DROPOFF(X,T),

In general, the prediction is a weighted combination of how many actual bookings already exist at location X and time T, as well as how many usual bookings are there at location X and time T. More and more weight is put on the former as the booking time T_{book} gets closer to the pickup time T.

However, this does not take into account pickups and dropoffs at intermediate times, so more accurate formulae should be:

Predicted no. of pickups at location X between times T_{book} and T=Σ_{s=T}_{_{book}}^{T}PICKUP.RESERVE(X,S)+(1−PROP.BOOK(T_{book};X,S))PICKUP(X,S),

and

Predicted no. of dropoffs at location X between times T_{book} and T Σ_{s=T}_{_{book}}^{T}DROPOFF.RESERVE(X,S)+(1−PROP.BOOK(T_{book};X,S))DROPOFF(X,S).

This gives a formula for PRED(X, T) made at booking time T_{book}:

PRED(X,T)=No. of rental cars at location X now (i.e., at booking time T_{book})−Σ_{s=T}_{_{book}}^{T}PICKUP.RESERVE(X,S)+(1−PROP.BOOK(T_{book};X,S))PICKUP(X,S)+Σ_{s=T}_{_{book}}^{T}DROPOFF.RESERVE(X,S)+(1−PROP.BOOK(T_{book};X,S))DROPOFF(X,S). (Eq.1)

It is appreciated that other formulae may be used for Eq. 1, for example, derived from fitting a statistical model to past booking data and other relevant factors.

### Example One

### Dropoff Location and Time are Known

In this example, a method of the present disclosure includes:

1. At time T_{book}, receive booking to pick up at location X_{pickup} and time T_{pickup}, and dropoff at location X_{dropoff} and time T_{dropoff}.

2. Compute PRED(X_{pickup}, T_{pickup}) and PRED(X_{dropoff}, T_{dropoff}), the estimated actual number of rental cars at these two locations and times, using Eq.1.

3. In one embodiment, if PRED(X_{pickup}, T_{pickup})≦0, then no car is available at location X_{pickup} and time T_{pickup}, so reject booking and STOP. In other embodiments, a booking may be rejected, if PRED(X_{pickup}, T_{pickup})≦1 or some other number.

4. Compute TARGET(X_{pickup}, T_{pickup}) and TARGET(X_{dropoff}, T_{dropoff}).

5. Compute the ratios:

$${R}_{pickup} = \frac{PRED ( {X}_{pickup} , {T}_{pickup} ) - 1}{TARGET ( {X}_{pickup} , {T}_{pickup} )} , \\ and$$

$${R}_{dropoff} = \frac{PRED ( {X}_{dropoff} , {T}_{dropoff} ) - 1}{TARGET ( {X}_{dropoff} , {T}_{dropoff} )} .$$

6. Compute the discount function: D=R_{pickup}/R_{dropoff}. Because D is not defined in the case where TARGET(X_{pickup}, T_{pickup})=0, the following cases are proposed:

D=1, if TARGET(X_{pickup},T_{pickup})=0 and TARGET(X_{dropoff},T_{dropoff})>0;

and

D=1+D_{K},if TARGET(X_{pickup},T_{pickup})=0 and TARGET(X_{dropoff},T_{dropoff})>0.

7. If D≦D₁, then offer rental car at the full price P_{full}, else offer rental car at the price Pₖ such that Dₖ<D≦Dₖ₊₁. In one embodiment, the price information (P_{full} or Pₖ) is transmitted to a user via a computer network, and displayed on the user's computer screen as a portion of the graphic user interface.

In one embodiment, the K discount function thresholds Dₘ (for m® t . . . K) may be related to the K+1 prices Pₙ (for n=0, 1, . . . K) using a predetermined lookup table. For instance, if a discount function value D is less than threshold D₁, then the rental company offers a full rental price P₀. On the other hand, if a discount function value D falls between thresholds of D₁ and D₂, then the rental company offers a discounted rental price of P₂.

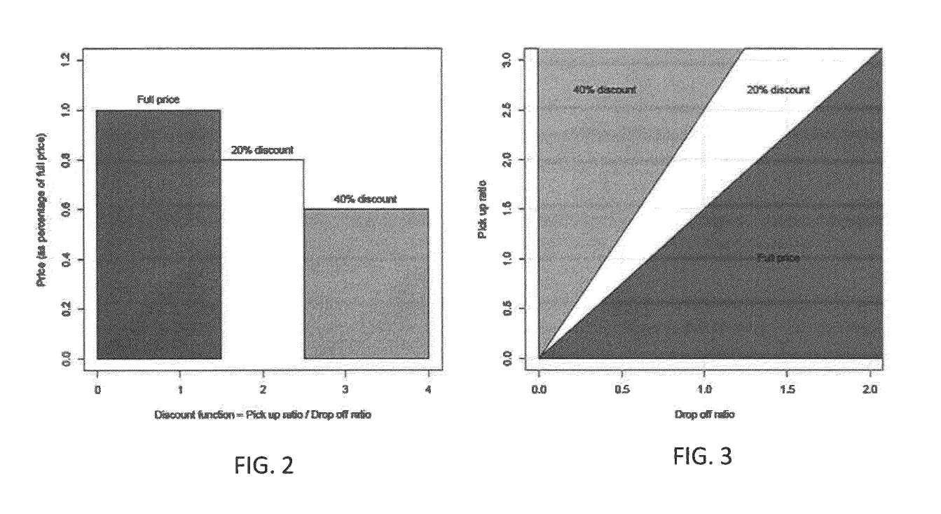

In one embodiment, the pricing method of the present disclosure can set two discount prices respectively at 80% and 60% of the full price (i.e., at 20% and 40% discount), and the discount thresholds D₁ and D₂ may be set at 1.5 and 2.5. FIG. 2 illustrates the price offered as a function of the discount function D, whereas FIG. 3 illustrates the price as a function of ratios R_{pickup} and R_{dropoff}.

### Example Two

### Dropoff Location and Time are Unknown

In this example, the only difference with EXAMPLE ONE is that, since the dropoff location and time are unknown, PRED(X_{dropoff}, T_{dropoff}) and TARGET(X_{dropoff}, T_{dropoff}) are also unknown, Therefore, R_{dropoff} cannot be calculated. All other aspects remain unchanged.

What is known from the past data (or past booking data) is what proportion of rental cars go from location X_{pickup} at time T_{pickup} to different locations in the city. Let p(X_{pickup}→T_{pickup}→T) be the proportion of cars booked at location X_{pickup} at time T_{pickup} that are dropped off at location X at time T, which can be derived from the past data. For example, with reference to locations in above TABLE 4, suppose that 20% of all cars picked up in Downtown West at midnight on a Monday are dropped off 30 minutes later in Jubilee Park, then p(X_{pickup}=Downtown West X=Jubilee Park, T_{pickup}=Monday 0:00 T=Monday 0:30)=0.2. Subsequently, R_{dropoff} can be estimated by the average value over the possible dropoff locations:

$${\hat{R}}_{dropoff} = \frac{{\sum }_{x} {\sum }_{T} ( PRED ( X , T ) + 1 ) p ( {X}_{pickup} -> X , {T}_{pickup} -> T )}{{\sum }_{x} {\sum }_{T} TARGET ( X , T ) p ( {X}_{pickup} -> X , {T}_{pickup} -> T )} .$$

In this example, a method of the present disclosure includes:

1. At time T_{book}, receive booking to pick up at location X_{pickup} and time T_{pickup}.

2. Compute PRED(X_{pickup}, T_{pickup}). Compute PRED(X, T) for all X and T for which p(X_{pickup}→c, T_{pickup}→t)>0, using ail.

3. In one embodiment, if PRED(X_{pickup}, T_{pickup})<0 then no car is available, so reject booking and STOP. In other embodiments, a booking may be rejected, if PRED(X_{pickup}, T_{pickup})≦1 or some other number.

4. Compute TARGET(X_{pickup}, T_{pickup}) and TARGET(X, T) for all X and T for which P(X_{pickup}→x, T_{pickup}→t)>0.

5. Compute the ratios:

$${R}_{pickup} = \frac{PRED ( {X}_{pickup} , {T}_{pickup} ) - 1}{TARGET ( {X}_{pickup} , {T}_{pickup} )} , \\ and$$

$${\hat{R}}_{dropoff} = \frac{{\sum }_{x} {\sum }_{T} ( PRED ( X , T ) + 1 ) p ( {X}_{pickup} -> x , {T}_{pickup} -> t )}{{\sum }_{x} {\sum }_{T} TARGET ( X , T ) p ( {X}_{pickup} -> x , {T}_{pickup} -> t )} .$$

6. Compute the discount function: D=R_{pickup}/\hat{R}_{dropoff}. Because D is not defined in the case where TARGET(X_{pickup}, T_{pickup})=0, the following cases are proposed:

D=if TARGET(X_{pickup},T_{pickup})=0 and ΣₓΣ_{T} TARGET(X,T)p(X_{pickup}→X,T_{pickup}→t)=0;

and

D=1+D_{K}, if TARGET(X_{pickup},T_{pickup})=0 and ΣₓΣ_{T} TARGET(X, T) p(X_{pickup}→x, T_{pickup}→t)>0.

7. If D≦D₁, then offer car at the full price P_{full}, else offer car at the price Pₖ such that Dₖ<D≦Dₖ₊₁.

In this example, the method of the present disclosure terminates after a price (P_{full} or Pₖ) is offered to a user and displayed on the user's computer screen.

### Example Three

### With Possible Dropoff Locations and Times

In this example, it is assumed that a booking request does not include dropoff location and time, and an alternative approach is implemented. Specifically, several possible dropoff locations and times are predicted based on, for example, the known pickup location and time, and a booking price for each of the possible dropoff locations and times is calculated. The booking price information for all the possible dropoff locations and times can be conveyed to the user through a map displayed on a client terminal device as a graphic user interface, with each of the possible dropoff locations being identified on the map, so as to allow the user to select a dropoff location.

In this example, a method of the present disclosure includes:

1. At time T_{book}, receive a booking request to pick up a rental vehicle at time T_{pickup} (which may be the current time T_{book} or any later time) and location X_{pickup},

2. Determine a plurality of possible dropoff locations X_{dropoff} and times T_{dropoff} based at least in part on the received pickup location X_{pickup} and pickup time T_{pickup}. It is appreciated that possible dropoff locations X_{dropoff} and times T_{dropoff} can be determined in accordance with other parameters, such as the current inventory of assets at locations neighboring the pickup location X_{pickup}, future booking data of other users' expected pick-ups and drop-offs at possible dropoff locations X_{dropoff} and times T_{dropoff}, etc.

3. Compute a price Pᵣ, for each of the possible dropoff locations X_{dropoff} and times T_{dropoff}, using the same method of EXAMPLE ONE, as if the dropoff times and locations are actually known.

4. Provide a summary of the computed prices on a map, by indicating where and when discounted prices are available.

5. Permit the dropoff time to be defined as the pickup time plus the travel time required to move a vehicle to the dropoff location.

It is appreciated that the system and method of the present disclosure can be implemented as a standalone computer program product stored in a computer readable medium, and executable by a processor of a computer hardware. Alternatively, the system and method of the present disclosure can be implemented as a web-based computer software program executable on the client hardware (e.g., through a web browser program or a Java Virtual Machine), or executable at the server hardware (e.g., using server side scripting).

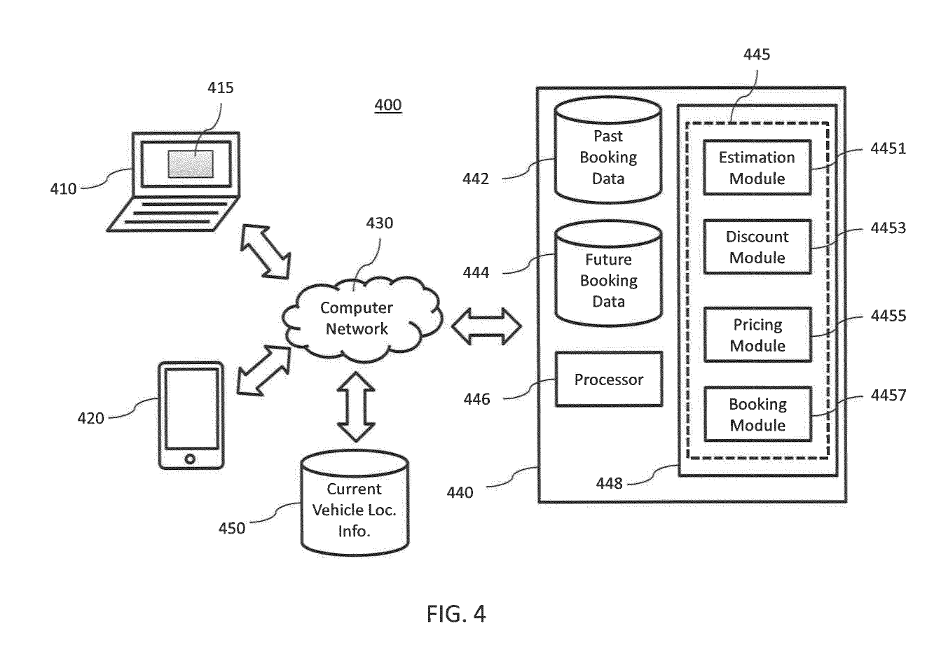

Referring to FIG. 4, there is illustrated a block diagram of a computer system 400 configured to implement a method for determining rental vehicle booking price, in accordance with an embodiment of the present disclosure. As shown in FIG. 4, computer system 400 includes a client terminal device 410 (or alternatively a mobile device 420) of a user, a computer network 430 (e.g., wide area network, local area network, wireless data network (e.g., LTE, WiMAX), and the like), and a server device 440. Server device 440 is made accessible by client terminal device 410 or mobile device 420 through computer network 430. In one embodiment, server device 440 may be a physical server machine (e.g., a blade server device) or a virtual machine (e.g., operating system level virtualization). In one embodiment, server device 440 includes a processor 446, memory 448, and first and second databases 442 and 444 hosted on server device 440. In one embodiment, first database 142 includes past book data, and second database 144 includes future booking data. Further, computer system 400 may comprise a third database 450 hosted by the rental car company, including current location data of all rental vehicles of the rental car company. It is appreciated that first and second databases 442 and 444 may be hosted together by server device 440 or separately hosted by different server devices. It is further appreciated that third database 450 may be a stand alone web-accessible database hosted by a separate server device, or a database that is hosted by server device 440 together with either one or both of first and second databases 442 and 444.

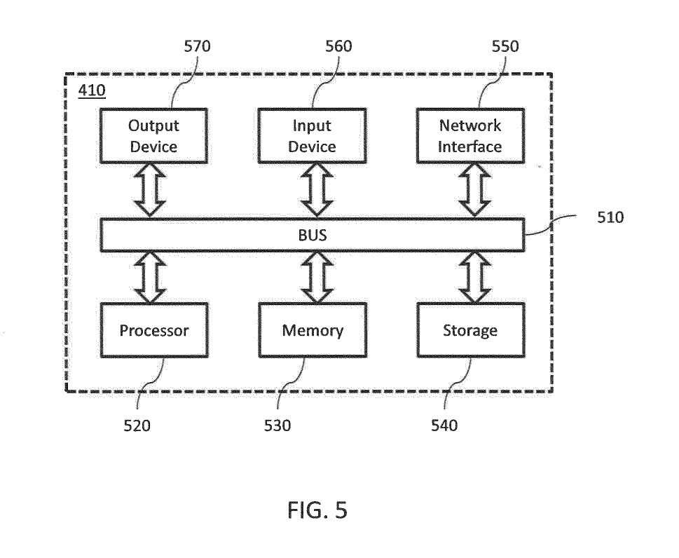

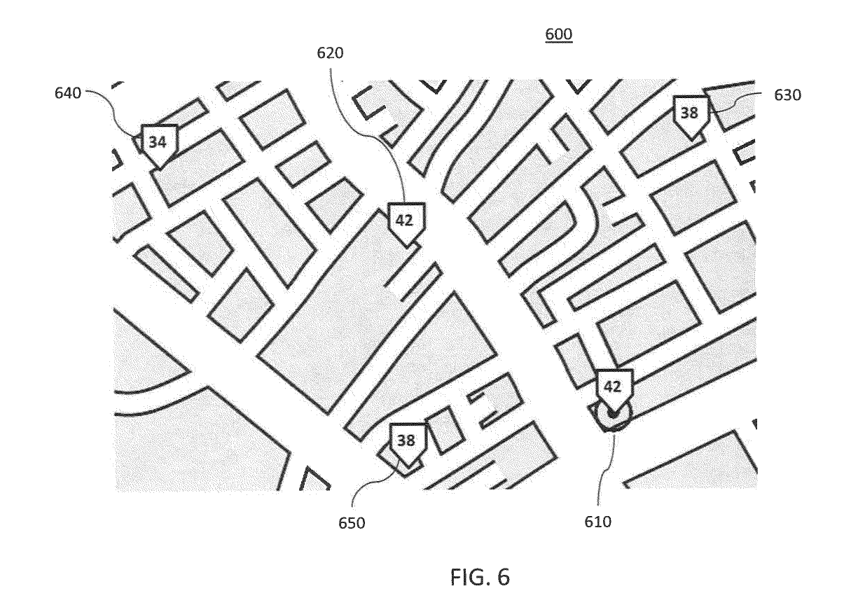

Referring to FIG. 5, there is illustrated a block diagram of a client terminal device 410 that is configured to implement a method for determining rental vehicle booking price, in accordance with an embodiment of the present disclosure. As shown in FIG. 5, client terminal device 410 includes an internal communication channel (or BUS) 510, a processor 520, memory 530, a computer readable mass storage device 540, a network interface 550, an input device 560, and an output device 570. Processor 520, memory 530 (e.g., random access memory, volatile memory, and the like), computer readable mass storage device 540 (e.g., hard drive, solid state drive, non-volatile memory, and the like), network interface 550 (e.g., wired or wireless network adapter, and the like), input device 560 (e.g., keyboard, pointer device, touch screen, and the like), and output device 570 (e.g., display screen, and the like) are coupled with each other through internal communication channel 510. Although client terminal device 410 is shown and described, it is appreciated that mobile device 420 comprises the same components as that of client terminal device 410, except as otherwise noted herein.

Referring to both FIGS. 4 and 5, in one embodiment, a first computer program product 415, such as a web browser program (in the case of client terminal device 410) or a standalone web-enabled mobile app (in the case of mobile device 420), can be executed on processor 520 of client terminal device 410 or mobile device 420 to display features on output device 570 of client terminal device 410 or mobile device 420, the displayed features interacting with the user as a frontend interface. The first computer program product receives a booking request from the user through the displayed features, and transmit the booking request to service device 440 through network interface 550. In one embodiment, the booking request comprises booking information such as booking time, pickup time and location, and optional dropoff time and location.

Referring again to both FIGS. 4 and 5, in one embodiment, a second computer program product 445, such as a server side scripting program, can be stored in memory 448 and executed by processor 446 of server device 440 to determine a booking price in response to the booking request. In one embodiment, the second computer program product 445 comprises a booking estimation module 4451, a discount determination module 4453, a price determination module 4455, and a booking module 4457.

In one embodiment, booking estimation module 4451 receives a booking request including a pickup location and a pickup time and in response calculates a predicted number of vehicles at the pickup location and the pickup time (i.e., PRED(X_{pickup}, T_{pickup}) as described above) based at least in part on the future booking data stored in second database 444 and the vehicle current location information stored in third database 450, and calculate a target number of vehicles at the pickup location and the pickup time (i.e., TARGET(X_{pickup}, T_{pickup}) as described above) based at least in part on past booking data.

If the calculated PRED(X_{pickup}, T_{pickup}) is less than zero or a predetermined value, then no car or insufficient car is available at location X_{pickup} and time T_{pickup}. Accordingly, booking estimation module 4451 of second computer program product 445 determines to terminate the booking process and transmit a rejection result to first computer program product 415 in response to the booking request.

In one embodiment, if the booking request is not rejected, discount determination module 4453 receives the calculated results of the predicted number of vehicles and the target number of vehicles from booking estimation module 4451, and calculates a discount function D as described above, in accordance with the calculated results from booking estimation module 4451.

In one embodiment, price determination module 4455 receives the discount function D from discount determination module 4453, and generates a proposed booking price P in accordance with the discount function D. Proposed booking price P may be generated in accordance with a pre-determined lookup table as described above. Second computer program product 445 then transmits proposed booking price P to first computer program product 415, which is then displayed to the user on output device 520. If the user agrees with the booking price P, the user can use a feature of first computer program product 415 displayed on output device 520 of client terminal device 410 to accept offered booking price P, and transmit the acceptance information to booking module 4457 of second computer program product 445. Booking module 4457 then completes the booking process and updates the future booking data in second databases 444.

In one embodiment, booking estimation module 4451 receives a booking request including a pickup time and in response calculates a predicted number of vehicles at the pickup location and the pickup time (PRED(X_{pickup}, T_{pickup}) as described above) based at least in part on the future booking data stored in second database 444 and the vehicle current location information stored in third database 450, and calculate a target number of vehicles at the pickup location and the pickup time (i.e., TARGET(X_{pickup}, T_{pickup}) as described above) based at least in part on past booking data. As a result, several different combinations of possible pickup and dropoff locations can be provided to the user prior to actually booking a vehicle, thereby indicating to the user where and when discounted prices might be available. In one embodiment, the dropoff time can be defined as the pickup time plus the travel time required to move a vehicle to the dropoff location.

FIG. 6 illustrates a graphic user interface 600 of computer program product 415 displayed on client terminal device 410 including a plurality of possible dropoff locations and booking prices thereof associated with a pickup location, in accordance with an embodiment of the present disclosure. As shown in FIG. 6, graphic user interface 600 may be a street map including location identifiers 610, 620, 630, 640, and 650, indicating the locations where the rental car company operates as asset depots.

In one embodiment, each of identifiers 610, 620, 630, 640, and 650 includes a booking price offered by the rental company upon receipt of a booking request. A user can use a pointer device (e.g., mouse or touch screen) of client terminal device 410 to click on one of identifiers 610, 620, 630, 640, and 650, thereby selecting the dropoff location in accordance with the offered booking price. It is appreciated that a pickup location can be the same as or different from a dropoff location.

For example, if the user chooses to pick up a vehicle from location 610 and drop off at the same location 610, then the booking price for the vehicle is 42 cents per minute. Similarly, for example, if the user chooses to pick up a vehicle from location 610 and drop off at location 620, then the booking price for the vehicle is 42 cents per minute. Further, for example, if the user chooses to pick up a vehicle from location 610 and drop off at location 630, then the booking price for the vehicle is 38 cents per minute.

For the purposes of describing and defining the present teachings, it is noted that the term “substantially” may be utilized herein to represent the inherent degree of uncertainty that may be attributed to any quantitative comparison, value, measurement, or other representation. The term “substantially” may also be utilized herein to represent the degree by which a quantitative representation may vary from a stated reference without resulting in a change in the basic function of the subject matter at issue.

Although the present disclosure has been described with respect to various embodiments, it would be apparent to one of ordinary skill in the art that various other embodiments are possible, without departing from the spirit and scope as defined in the appended claims.

What is claimed is:

1. A method for balancing rental fleet of ovable assets, the method being executed by a processor and comprising:
receiving, at a booking time, a booking request for an asset, the booking request including a pickup location and a pickup time;
in response to the booking request, calculating a predicted quantity of assets at the pickup location and the pickup time based at least in part on current asset location information and future booking data, and calculating a target quantity of assets at the pickup location and the pickup time based on past booking data;
calculating a discount parameter in accordance with said predicted quantity of assets and said target quantity of assets; and
generating a booking price in accordance with the discount parameter.

2. The method of claim 1, further comprising rejecting the booking request when the predicted quantity of assets is less than or equal to a predetermined quantity.

3. The method of claim 1, wherein calculating the predicted quantity of assets comprises:
retrieving a first quantity of assets that is actually located at the pickup location at the booking time in accordance with the current asset location information;
subtracting from the first quantity a second quantity of assets to be picked up from the pickup location between the booking time and the pickup time in accordance with the future booking data; and
adding to the first quantity a third quantity of assets to be dropped off to the pickup location between the booking time and the pickup time in accordance with the future booking data.

4. The method of claim 1, wherein the booking price is a full price when the discount parameter is less than or equal to a predetermined discount threshold value.

5. The method of claim 1, wherein the booking price is a discounted price when the discount parameter is greater than a predetermined discount threshold.

6. The method of claim 1, wherein calculating the discount parameter comprises calculating a pickup ratio and a dropoff ratio, and calculating a fraction of the pickup ratio and the dropoff ratio.

7. The method of claim 6, wherein calculating the pickup ratio comprises:
calculating a first fraction of a first numerator and a first denominator;
wherein the first numerator is the predicted quantity of assets at the pickup location and the pickup time subtracted by a value one; and
wherein the first denominator is the target quantity of assets at the pickup location and the pickup time.

8. The method of claim 6, wherein the booking request further includes a dropoff location and a dropoff time, and wherein calculating the dropoff ratio comprises:
calculating a predicted quantity of assets at a dropoff location and a dropoff time based at least in part on the current asset location information and the future booking data;
calculating a target quantity of assets at the dropoff location and the dropoff time based on past booking data; and
calculating a second fraction of a second numerator and a second denominator;
wherein the second numerator is the predicted quantity of assets at the dropoff location and the dropoff time added by a value one; and
wherein the second denominator is the target quantity of assets at the dropoff location and the dropoff time.

9. The method of claim 6, wherein calculating the dropoff ratio comprises:
calculating a proportion of booked assets to be picked up at the pickup location and the pickup time, and to be dropped off at a plurality of dropoff locations and a plurality of dropoff times;
calculating a predicted quantity of assets at said plurality of dropoff locations and said plurality of dropoff times based at least in part on the current asset location information and the future booking data;
calculating a target quantity of assets at said plurality of dropoff locations and said plurality of dropoff times based on past booking data; and
calculating the dropoff ratio in accordance with
$${\hat{R}}_{dropoff} = \frac{{\sum }_{x} {\sum }_{T} ( PRED ( X , T ) + 1 ) p ( {X}_{pickup} -> X , {T}_{pickup} -> T )}{{\sum }_{x} {\sum }_{T} TARGET ( X , T ) p ( {X}_{pickup} -> X , {T}_{pickup} -> T )} ,$$
wherein \hat{R}_{dropoff} denotes the dropoff ratio;
wherein PRED(X, T) denotes the predicted quantity of assets at said plurality of dropoff locations X and said plurality of dropoff times T;
wherein TARGET(X, T) denotes the target quantity of assets at said plurality of dropoff locations X and said plurality of dropoff times T;
wherein p(X_{pickup}→X, T_{pickup}→T) denotes a proportion of assets booked at the pickup location and the pickup time and dropped off at said plurality of dropoff locations X and said plurality of dropoff times T; and
wherein ΣₓΣ_{T} denotes summations over said plurality of dropoff locations X and said plurality of dropoff times T.

10. A computer program product stored in a computer readable medium, the computer program product when executed by a computer processor, causing the computer processor to perform a method for balancing rental fleet of movable assets, the method comprising:
receiving, at a booking time, a booking request for a asset, the booking request including a pickup location and a pickup time;
in response to the booking request, calculating a predicted quantity of assets at the pickup location and the pickup time based at least in part on current asset location information and future booking data, and calculating a target quantity of assets at the pickup location and the pickup time based on past booking data;
calculating a discount parameter in accordance with said predicted quantity of assets and said target quantity of assets; and
generating a booking price in accordance with the discount parameter.

11. The computer program product claim 10, wherein the method further comprises rejecting the booking request when the predicted quantity of vehicles is less than or equal to a predetermined quantity.

12. The computer program product claim 10, wherein calculating the predicted quantity of assets comprises:
retrieving a first quantity of assets that is actually located at the pickup location at the booking time in accordance with the current asset location information;
subtracting from the first quantity a second quantity of assets to be picked up from the pickup location between the booking time and the pickup time in accordance with the future booking data; and
adding to the first quantity a third quantity of assets to be dropped off to the pickup location between the booking time and the pickup time in accordance with the future booking data.

13. The computer program product claim 10, wherein the booking price is a full price when the discount parameter is less than or equal to a predetermined discount threshold value.

14. The computer program product claim 10, wherein the booking price is a discounted price when the discount parameter is greater than a predetermined discount threshold.

15. The computer program product claim 10, wherein calculating the discount parameter comprises calculating a pickup ratio and a dropoff ratio, and calculating a fraction of the pickup ratio and the dropoff ratio.

16. The computer program product claim 15, wherein calculating the pickup ratio comprises:
calculating a first fraction of a first numerator and a first denominator;
wherein the first numerator is the predicted quantity of assets at the pickup location and the pickup time subtracted by a value one; and
wherein the first denominator is the target quantity of assets at the pickup location and the pickup time.

17. The computer program product claim 15, wherein the booking request further includes a dropoff location and a dropoff time, and wherein calculating the dropoff ratio comprises:
calculating a predicted quantity of assets at a dropoff location and a dropoff time based at least in part on the current asset location information and the future booking data;
calculating a target quantity of assets at the dropoff location and the dropoff time based on past booking data; and
calculating a second fraction of a second numerator and a second denominator;
wherein the second numerator is the predicted quantity of assets at the dropoff location and the dropoff time added by a value one; and
wherein the second denominator is the target quantity of assets at the dropoff location and the dropoff time.

18. The computer program product claim 15, wherein calculating the dropoff ratio comprises:
calculating a proportion of booked assets to be picked up at the pickup location and the pickup time, and to be dropped off at a plurality of dropoff locations and a plurality of dropoff times;
calculating a predicted quantity of assets at said plurality of dropoff locations and said plurality of dropoff times based at least in part on the current asset location information and the future booking data;
calculating a target quantity of assets at said plurality of dropoff locations and said plurality of dropoff times based on past booking data; and
calculating the dropoff ratio in accordance with
$${\hat{R}}_{dropoff} = \frac{{\sum }_{x} {\sum }_{T} ( PRED ( X , T ) + 1 ) p ( {X}_{pickup} -> X , {T}_{pickup} -> T )}{{\sum }_{x} {\sum }_{T} TARGET ( X , T ) p ( {X}_{pickup} -> X , {T}_{pickup} -> T )} ,$$
wherein \hat{R}_{dropoff} denotes the dropoff ratio;
wherein PRED(X, T) denotes the predicted quantity of assets at said plurality of dropoff locations X and said plurality of dropoff times T;
wherein TARGET(X, T) denotes the target quantity of assets at said plurality of dropoff locations X and said plurality of dropoff times T;
wherein p(X_{pickup}→X, T_{pickup}→T) denotes a proportion of assets booked at the pickup location and the pickup time and dropped off at said plurality of dropoff locations X and said plurality of dropoff times T; and
wherein Σₓ Σ_{T} denotes summations over said plurality of dropoff locations X and said plurality of dropoff times T.

19. A computer system for balancing rental fleet of movable assets, the system comprising:
a processor and memory coupled to the processor;
a booking estimation module in the memory and configured to:
receive, at a booking time, a booking request for a asset, the booking request including a pickup location and a pickup time,
calculate a predicted quantity of assets at a pickup location and a pickup time based at least in part on current asset location information and future booking data, and
calculate a target quantity of assets at the pickup location and the pickup time based on past booking data;
a discount determination module in the memory and configured to calculate a discount parameter in accordance with said predicted quantity of assets and said target quantity of assets;
a price determination module in the memory and configured to generate a booking price in accordance with the discount parameter; and
a booking module in the memory and configured to complete the booking request.

20. A method for balancing rental fleet of movable assets, the method being executed by a processor and comprising:
receiving, at a booking time, a booking request for an asset, the booking request including a pickup location and a pickup time;
determining a plurality of possible dropoff locations and a plurality of possible dropoff times in accordance with the pickup location and the pickup time;
calculating a plurality of discount parameters in accordance with said pickup location, said pickup time, said possible dropoff locations, and said possible dropoff times, one of the discount parameters being associated with one of the possible dropoff locations; and
generating a plurality of booking prices in accordance with said discount parameters, one of the booking prices being associated with one of the possible dropoff locations.

21. The method of claim 1, wherein each of the possible dropoff times is an estimate of time that is required to move an asset from the pickup location to a respective possible dropoff location.

22. The method of claim 20, wherein calculating the discount parameters comprises
calculating a first predicted quantity of assets at the pickup location and the pickup time based at least in part on current asset location information and future booking data;
calculating a first target quantity of assets at the pickup location and the pickup time based on past booking data;
calculating a second predicted quantity of assets at the possible dropoff locations and the possible dropoff times based at least in part on current asset location information and future booking data;
calculating a second target quantity of assets at the possible dropoff locations and the possible dropoff times based on past booking data; and
calculating the discount parameters in accordance with the first predicted quantity, the first target quantity, the second predicted quantity, and the second target quantity.

23. The method of claim 20, further comprising:
displaying a plurality of location identifiers on a graphic user interface of a client terminal device representing location information of the possible dropoff locations, wherein each of the location identifiers is associated with one of the booking prices.
